(19) United States
(12) Patent Application Publication
(10) Pub. No.: US 2008/0060289 A1
(43) Pub. Date: Mar. 13, 2008

(54) Flashing for integrating windows with weather resistant barrier

(76) Inventors: Ashok Harakhlal Shah, Midlothian, VA (US); Mark Stefan Ludwig, Phoenix, AZ (US); Robert Bates Hagood, Wilmington, DE (US); Andrew Barnes Anderson, Chester, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/519,261

(22) Filed: Sep. 11, 2006

(51) Int. Cl. E06B 3/30

(52) U.S. Cl. 52/204.53

(57) ABSTRACT

A self-adhesive flashing for integrating a flanged fenestration unit installed in a rough opening in a wall with a weather resistive barrier is disclosed where the flashing includes an elongated substrate having a pressure-sensitive adhesive layer adhered to one side of the substrate such that a first portion of the adhesive layer covers a portion of the substrate adjacent a lateral edge of the substrate and a second portion of the adhesive layer extends beyond the lateral edge.

### BACKGROUND OF THE INVENTION

1. Field of the Invention

The present invention relates to flashing for preventing the ingress of moisture into a wall of a building around an installed window, the window having an integral nailing flange, and to a method for installing the flashing in such a way that it is integrated with the framing members of the wall, the window flange and a weather resistive barrier.

2. Description of the Related Art

In “open-stud” building construction, windows and other fenestration products are installed directly into building openings formed by framing members (e.g., wood studs) prior to the installation of weather resistive barrier (“WRB”) over the framing members which form the wall cavities. Two types of flashing are known for use in open-stud construction. One type of flashing is “nail-on flashing” comprising a strip of water-impermeable film which is nailed to the wood studs before a window is installed such that, upon window installation, the edge of the flashing is covered by the window flange. A second type of flashing is “self-adhered flashing” which comprises a water-impermeable film with a strip of adhesive along the edge for attachment to the window flange along the vertical jambs and the horizontal head of the window, wherein the adhesive is covered by a release liner. Self-adhered flashing can also comprise adhesive over an entire surface. Weather resistive barrier is subsequently installed over the framed walls of the building such that around the window, the weather resistive barrier covers the flashing at the vertical jambs and head of the window and is layered behind the flashing at the window sill.

According to conventional practice in open-stud construction, the space between the weather resistive barrier and the flashing at the vertical jambs and head is not sealed, thus creating the possibility of rainwater entering between the WRB and the flashing. The purpose of the flashing is to divert such water down and eventually to the outside of the WRB at the sill. Under excessive wind forces, water that has entered the space behind the WRB can travel beyond the width of the flashing into the wall cavity which may result in moisture damage to the framing members, such as rotting of wood studs and loss of insulation.

It would be desirable to have a cost-effective means for reducing the likelihood of water penetration into wall cavities around flanged fenestration units in open-stud building construction.

### SUMMARY OF THE INVENTION

One embodiment of the invention relates to a flashing for integrating a flanged fenestration unit, a rough opening in a wall and a weather resistive barrier, the flashing comprising:
a. an elongated substrate selected from the group consisting of nonwoven fabric, woven fabric, film, paper, sheet metal, and a combination thereof;
b. an elongated adhesive layer having an inner adhesive surface and an outer adhesive surface, wherein the outer adhesive surface is adhered to one side of the substrate such that a first portion of the adhesive layer covers a portion of the substrate adjacent a lateral edge of the substrate and a second portion of the adhesive layer extends beyond the lateral edge;
c. release liners covering each of the inner adhesive surface and the outer adhesive surface of the adhesive layer.

Another embodiment of the invention relates to a method for preventing the ingress of moisture into a wall of a building surrounding a flanged fenestration unit installed in a rough opening of the wall, the wall and the rough opening being defined by framing members, the method comprising:
a. installing the fenestration unit in the rough opening such that the flange of the fenestration unit overlaps the framing members of the rough opening;
b. providing a flashing comprising an elongated substrate selected from the group consisting of nonwoven fabric, woven fabric, film, paper, sheet metal, and a combination thereof, and an elongated adhesive layer having an inner adhesive surface and an outer adhesive surface, wherein the outer adhesive surface of the adhesive layer is adhered to one side of the substrate such that a first portion of the adhesive layer covers a portion of the substrate adjacent a lateral edge of the substrate and a second portion of the adhesive layer extends beyond the lateral edge;
c. adhering the inner adhesive surface of the adhesive layer of the flashing to the flange of the fenestration unit along the sides and uppermost portion of the fenestration unit and to the adjacent framing members of the rough opening; and
d. installing a weather resistive barrier over the wall surrounding the fenestration unit such that the weather resistive barrier is adhered to the outer adhesive surface of the second portion of the adhesive layer along the sides and uppermost portion of the fenestration unit and such that the weather resistive barrier immediately below the lowermost portion of the fenestration unit is covered by the substrate of the flashing.

### BRIEF DESCRIPTION OF THE DRAWINGS

FIG. 1 is an exploded view of the flashing of the invention.

FIG. 2 is a cross-sectional side view of the flashing of the invention.

FIGS. 3a, 3b, and 3c illustrate a method for utilizing the flashing of the invention in an open-stud wall construction.

### DETAILED DESCRIPTION OF THE INVENTION

The invention relates to an improved flashing product for use along the vertical jams, head, and sill of a flanged fenestration unit, such as a window, that integrates the peripheral flange of the fenestration unit, with the framing members defining a rough opening in a wall, and further integrates the flange and framing members with a weather resistive barrier. The use of the improved flashing product prevents the ingress of moisture into the wall cavity surrounding the fenestration unit. It should be appreciated that when the term “window” is used, other types of fenestration units, such as doors, skylights, vents, utility supply boxes, and other items that are made to fit into openings in structures, such as buildings, could be substituted.

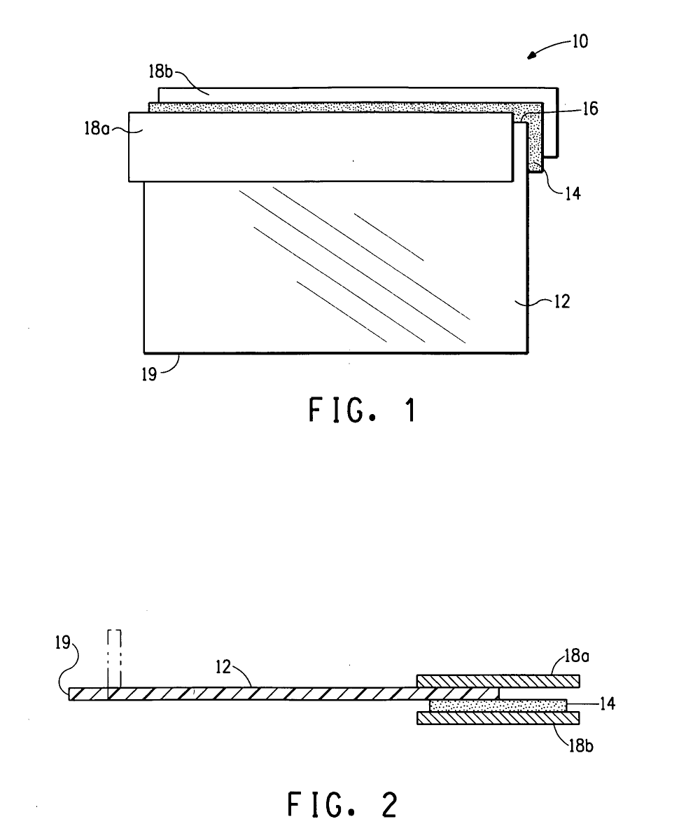

FIGS. 1 and 2 illustrate an exploded view and a cross-sectional side view, respectively, of the flashing 10 of the invention. It should be noted that the drawings are not to scale and are non-limiting in that respect.

The flashing 10 comprises a substrate 12 having a single adhesive layer 14 on one surface thereon extending beyond a lateral edge 16 of the substrate such that the adhesive is exposed on both sides of the portion of the adhesive layer extending beyond lateral edge 16. The adhesive surfaces of the adhesive layer are covered by release liners 18a and 18b, referred to as the top release liner and the bottom release liner, respectively. Although not depicted in FIG. 2 for the sake of simplicity, it should be noted that the portion of release layer 18a extending beyond the substrate 12 would be in contact with the portion of adhesive 14 that is not covered by substrate 12.

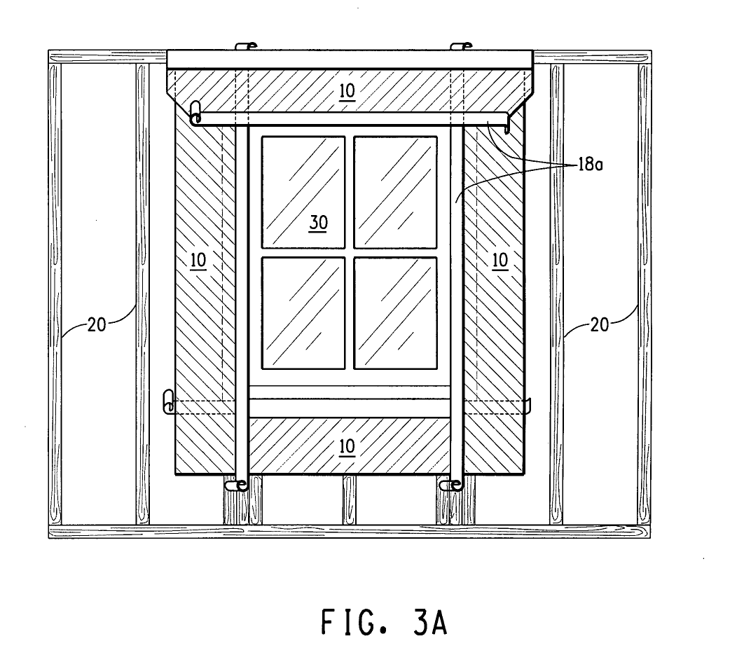

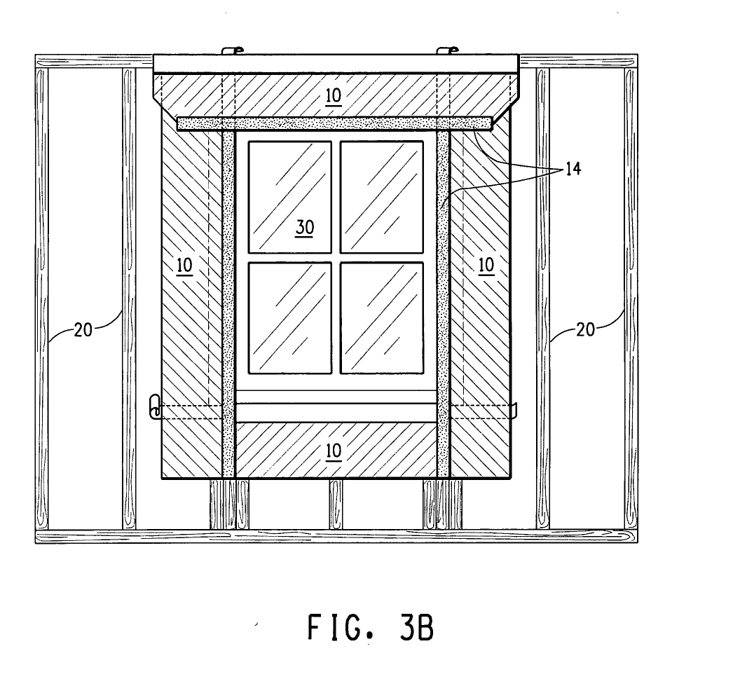

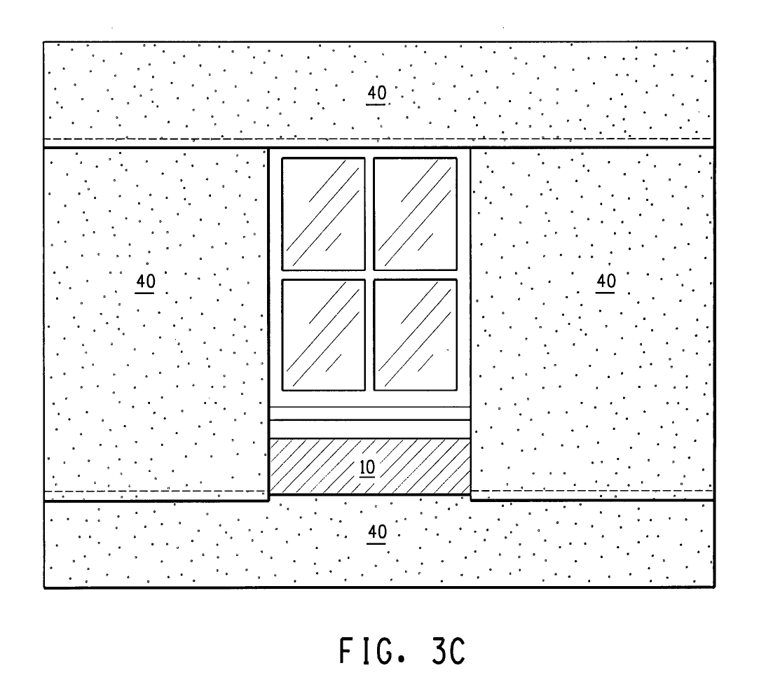

The adhesive layer 14 integrates the window flange, the framing member and the WRB in use. The adhesive layer has an inner adhesive surface, referring to the surface of the adhesive layer that faces the interior of the building when ultimately installed, and an outer adhesive surface, referring to the surface of the adhesive layer that faces the exterior of the building when ultimately installed. Once the bottom release liner 18B is removed from the flashing, the inner adhesive surface is adhered to the window flange and the framing member immediately adjacent the window flange. The outer adhesive surface covers the portion of the substrate 12 immediately adjacent the lateral edge 16 of the adhesive layer 14 and extends beyond the lateral edge 16. Once the top release liner 18a is removed, the outer adhesive surface of the adhesive layer is available to be adhered to the WRB, and thus integrates the WRB on the outer side of the flashing with the window flange and framing member on the inner side of the flashing. It is the integration of the framing member, window flange and WRB that prevents the ingress of water into the wall cavity behind the WRB around the window. FIG. 3A illustrates an open-stud construction wall comprising framing members 20, installed window 30 and flashing 10 installed around the window, before the installation of the WRB and before the top release liner 15a on the flashing is removed. FIG. 3B illustrates the same wall after the top release liner 18a on the flashing is removed to expose adhesive layer 14. FIG. 3C illustrates the same wall after the installation of the WRB 40.

Since some known window flange materials deform under extreme heat, it may be desirable for the width of the portion of the adhesive layer extending beyond the lateral edge to be less than the width of the window flange, so that the edge of the window flange is covered by the substrate 12. This reduces the likelihood that this portion of the adhesive will be stretched and weakened during use.

The substrate 12 of the flashing of the invention can be a film, sheet metal, nonwoven fabric, woven fabric, paper, rigid plastic, or a combination thereof. In addition, the substrate can be reinforced with a fiberglass scrim or the like. The substrate is water impermeable and can be either water vapor permeable or water vapor impermeable. The substrate can be a material that has been made water impermeable by the use of a water impermeable coating. The substrate can be a nail-sealable film such as Titanium-UDL™ roof underlayment commercially available from InterWrap Inc. of Canada. The flashing can be at least 9 inch wide if required by applicable industry standards, e.g., ASTM E 2112; otherwise it can be less than 9 inches wide.

The substrate 12 should be dimensionally stable and durable under the conditions of temperature and humidity experienced by the flashing in use. The substrate should not shrink or curl which could result in delamination of the flashing or separation of the flashing from the framing member or window flange. Such separation could create channels through which water could migrate into the wall cavity surrounding the window flange. For ease of installation of the flashing of the invention, the substrate should have sufficient stiffness so it does not easily fold over on itself with at the upper corners of the window. The substrate should be tear resistant.

The substrate 12 should not react with the adhesive layer 14 in a manner detrimental to the structural integrity and dimensional stability of the substrate. In case of a polymeric substrate, the substrate is made of a polymer having a sufficiently high softening temperature. Suitable polymers include polyethylene, polypropylene, polyethylene terephthalate, polyamide, or a blend or copolymer thereof. The substrate can include optional additives such as UV stabilizers, antioxidants, antimicrobial agents, pigments, etc. The substrate 12 can optionally be translucent if it is desirable for the framing elements 20 to be visible behind the installed flashing 10.

For enhanced adhesion with the adhesive layer 14, the substrate 12 can be subjected to a surface treatment, such as corona treatment or microembossing. The substrate can also be subjected to corona treatment for improved ink adhesion.

The adhesive used in adhesive layer 14 has good adhesion to the material of the substrate 12 as well as to a wide variety of construction materials, e.g., wood, aluminum, vinyl, and commonly used weather resistive barriers such as DuPont™ Tyvek® HomeWrap (available from E. I. du Pont de Nemours & Co., Wilmington, Del.). The adhesive is stable under conditions of heat and moisture over an extended period of time. Suitable adhesives for use in the flashing of the invention include butyl rubber adhesive, bituminous adhesive, acrylic, or combinations thereof (layers and blends). Additionally, the adhesive can be neoprene, a polymer based on EPDM (ethylene propylene diene monomer), or other pressure sensitive adhesives generally used in construction applications.

The adhesive layer 14 can be reinforced with a fine scrim such as a fiberglass mesh for increased mechanical integrity of the portion of the adhesive layer not supported by the substrate 12. It is desired to have the scrim extending by at least a short distance into the adhesive layer 14 covered by substrate 12 near the lateral edge of the substrate. The fiberglass mesh helps to prevent deformation of the adhesive during handling and installation of the flashing.

Optionally, near the lateral edge 19 of the substrate that is free of adhesive, the substrate is folded outward, i.e., towards the building exterior, as further protection from water migrating beyond the width of the flashing along the vertical jambs. This folding is depicted by the shadow lines in FIG. 2. It should be noted that although the folded portion is shown as perpendicular to the unfolded portion of the substrate, different orientations are suitable as long as the migration of water is minimized.

In use, the bottom release liner 18b is removed from the flashing before the top release liner 18a, and then the flashing is adhered to the window flange with the help of the exposed adhesive layer. It may be desirable to have higher adhesion between the adhesive layer and the top release liner than between the adhesive layer and the bottom release liner, so that the adhesive layer stays adhered to the top release liner while the bottom release liner is being peeled away during the installation of flashing on window flange.

The top release liner 18a can be provided with some level of water and UV resistance for limited outdoor exposure during building construction. The outer surface of the top release liner can be coated with a water resistant resin such as linear low density polyethylene, so that the adhesive bonds well to the outer surface of the release liner at locations where one piece of flashing crosses over another piece having the release liner covering the outer adhesive surface still in place during use, such as at the upper corners of a window. It is desirable for this release liner to be removed so that adhesive-to-adhesive contact occurs at these crossover locations. It is desirable for the release liner to be thin and flexible so that it will wind without excessive buckling when the flashing is wound onto a roll with the outer release liner on the inside of the roll.

The flashing of the invention is cost effective since adhesive surfaces on both sides of the flashing are provided in a single pass coating operation forming a single adhesive layer.

The invention also relates to a method for integrating WRB with framing members defining a rough opening in a wall and with the peripheral flange of a fenestration unit installed in the rough opening, in order to prevent the ingress of moisture into a wall cavity around the fenestration unit. A method for installing the flashing of the invention is described as follows. A fenestration unit such as a window is first installed in a rough opening such that the peripheral flange overlaps the adjacent framing members. The flange is advantageously secured to the underlying framing members via screws, nails etc. The inner surface of the adhesive layer of the flashing of the invention as described herein is adhered to and over the window flange and the adjacent framing members. Finally, WRB is installed over the wall surrounding the window and adhered to the outer surface of the adhesive layer of the flashing along the sides and uppermost portion of the window. The WRB is advantageously covered by the substrate of the flashing at the lowermost portion of fenestration unit.

The flashing can alternatively be installed by reversing the inner and outer adhesive surfaces of the adhesive layer and installing the flashing between the framing members and the window flange such that exposed adhesive layer faces out and extends beyond the window flange for integrating with the weather resistive barrier. This alternative method of installation generally requires a thicker adhesive layer in order to compensate for nonuniform gap between the flange and the framing member.

### Test Methods

Water Infiltration of a wall-window installation was performed according to ASTM E 331. The seal between the flashing and the WRB was challenged by water at the following infiltration pressures:

a. 0.1 in H₂O for 15 minutes

b. 0.3 in H₂O for 15 minutes

c. 1.2 in H₂O for 15 minutes

### EXAMPLES

For all of the following examples and comparative examples, the same open-stud wall construction and window were used. The wall (90 inch high by 60 inch wide) was constructed using 2 inch by 4 inch wood studs as framing members. The studs were spaced 16 inches apart, center to center. The studs formed a rough opening. A 28 in by 36 in model 2160 vinyl single-hung flanged window having a 1.25 in wide peripheral flange (manufactured by Silver Line, North Brunswick, N.J.) was installed in the rough opening in the wall.

### Examples 1-6

A 9 inch wide strip of 7 mil thick blown polypropylene resin water-impermeable film (obtained from Winzen Film and Fiber, Inc., Sulphur Springs, Tex.) was used as the elongated substrate in the flashing of these examples. Both surfaces of the film were corona treated, to improve the adhesion to butyl rubber adhesive on one surface, and to improve the adhesion to printing ink on the other surface. A 20 mil thick by 2.5 in wide layer of elongated butyl rubber adhesive was layered onto a portion of the corona treated surface along a lateral edge of the film substrate in an offset manner with respect to the substrate such that a first portion of the adhesive layer about 1.6 inches wide covered the substrate and a second portion of the adhesive layer extended beyond the lateral edge of the substrate by about 0.9 inch. The surface of the adhesive layer facing towards the film substrate is referred to as the outer surface, and the surface of the adhesive layer facing away from the substrate is referred to as the inner surface. Both exposed surfaces of the adhesive layer were covered with release liners.

In each of Examples 1-6, a wall was constructed as described above. A strip of either 60 minute grade D building paper, available under the tradename JumboTex® from Fortifiber Corporation (Reno, Nev.) or DuPont™ StuccoWrap®, as specified in Table 1, was used to create a skirt at the sill of the rough opening. DuPont™ FlexWrap® flexible flashing was then installed at the sill per DuPont guidelines. A 0.25 to 0.5 in bead of DAP® Dynaflex 230® acrylic latex caulk (available from DAP, Baltimore, Md.) was applied along the vertical jambs and head of the rough opening. The window was then set in place in the rough opening so that the bead of caulk was located under the window flange. Wood screws were used to anchor the window flange to the studs of the rough opening. The release liner covering the inner adhesive surface of a piece of flashing made as described above was removed and the flashing was installed along a vertical jamb, covering the window flange completely. In the same way, flashing was installed along the remaining vertical jamb and then along the head of the window. In Example 4, 9 inch wide DuPont™ Tyvek® StraightFlash™ was used at the head instead of the flashing of the invention. The remaining release liner covering the outer adhesive surface of the installed flashing was removed and either JumboTex® 60 minute grade D building paper or DuPont™ StuccoWrap®, as specified in Table 1, was installed as the WRB in a shingled manner to prevent water from penetrating beneath the WRB. The WRB was tucked behind the skirt at the sill.

### Comparative Example 1

A 9 inch wide strip of self-adhered flashing available under the trade name Moistop® E-Z Seal (available from Fortifiber Corporation, Reno, Nev.) was installed according to the manufacturer's recommended practice at the sill, jambs, and head, and a window was installed as in Examples 1-6. DuPont™ StuccoWrap® WRB was installed in a shingled manner. The WRB was not sealed around the window. The WRB was tucked behind the skirt at the sill.

### Comparative Examples 2-3

In Comparative Example 2, a 9 inch wide strip of nail-on flashing available under the trade name WaterBlock® (available from International Building Components, Inc. (IBC), Glenwood, N.Y.) was nailed to the wood stud framing members around the rough opening; first at the sill and then at the jambs and the head. Caulking was applied on the nail-on flashing around the rough opening. The window was then installed in the rough opening and secured with screws around the window flange. In Comparative Example 3, WaterBlock® flashing was installed per the manufacturer's recommended practice. Building paper WRB was installed in a shingled manner. The WRB was not sealed around the window. The WRB was tucked behind the skirt at the sill.

The wall-window installations of Examples 1-6 and Comparative Examples 1-3 were challenged according to the water infiltration test. The results are shown in Table 1.

TABLE 1

| Ex. | | | Water Infiltration Observations | | |
|---|---|---|---|---|---|
| No. | Sill | WRB | at 0.1 in H₂O | at 0.3 in H₂O | at 1.2 in H₂O |
| 1 | SW | SW | No infiltration | No infiltration | Some water |
| | | | | | infiltration* at head |
| 2 | BP | BP | No infiltration | No infiltration | No infiltration |
| 3 | Flashing | BP | No infiltration | Some water | Some water |
| | according | | | infiltration into | infiltration into wall |
| | to | | | wall cavity | cavity |
| | Examples | | | | |
| | 1–6 | | | | |
| 4 | SW | SW | No infiltration | No infiltration | No infiltration |
| 5 | SW | SW | No infiltration | No infiltration | Some water |
| | | | | | infiltration at head |
| 6 | BP | BP | No infiltration | No infiltration | No infiltration |
| Comp. | Moistop ® | SW | No infiltration | No infiltration | Heavy water |
| Ex. 1 | E–Z Seal | | | | infiltration** at |
| | flashing | | | | corners of sill |
| Comp. | WaterBlock ® | BP | Heavy | Heavy infiltration | Heavy infiltration at |
| Ex. 2 | 9 inch | | infiltration at left | at left jamb | left jamb |
| | nail-on | | jamb | | |
| | flashing | | | | |
| Comp. | WaterBlock ® | BP | No infiltration | Heavy infiltration | Heavy infiltration at |
| Ex. 3 | 9 inch | | | at jambs and | jambs and head |
| | nail-on | | | head | |
| | flashing | | | | |
| | combined | | | | |
| | with IBC | | | | |
| | self- | | | | |
| | adhered | | | | |
| | membrane | | | | |

*“Some water infiltration” indicates intermittent dripping or very low flow of water.
**“Heavy water infiltration” indicates continuous flow or intermittent stream of water.
SW = DuPont ™ StuccoWrap ®
BP = building paper

As indicated in Table 1, in Examples 1, 3, and 5, some water infiltration was observed at the interior of the wall in the wall-window installation at pressures of 0.3 and 1.2 inches of water while in Examples 2, 4, and 6, no water infiltration was observed. Overall, the water infiltration observed in Examples 1-6 was much less than that observed in Comparative Examples 1-3, each of which permitted heavy water infiltration.

What is claimed is:

1. A flashing for integrating a flanged fenestration unit, a rough opening in a wall and a weather resistive barrier, the flashing comprising:
a. an elongated substrate having a first lateral edge and second lateral edge, the substrate selected from the group consisting of nonwoven fabric, woven fabric, film, paper, sheet metal, and a combination thereof;
b. an elongated adhesive layer having an inner adhesive surface and an outer adhesive surface, wherein the outer adhesive surface is adhered to one side of the substrate such that a first portion of the adhesive layer covers a portion of the substrate adjacent the first lateral edge of the substrate and a second portion of the adhesive layer extends beyond the first lateral edge;
c. release liners covering each of the inner adhesive surface and the outer adhesive surface of the adhesive layer.

2. The flashing of claim 1, wherein the adhesive layer comprises butyl rubber adhesive.

3. The flashing of claim 2, wherein the adhesive layer comprises butyl rubber adhesive reinforced with fiberglass mesh.

4. The flashing of claim 1, wherein the adhesive layer is between about 1 inch and about 9 inches wide and the second portion of the adhesive layer is between about 0.5 inches and about 3 inches.

5. The flashing of claim 1, wherein width of the second portion of the adhesive layer is less than the width of the flange of the fenestration unit.

7. The flashing of claim 1, wherein the adhesion between the release liner covering the outer adhesive surface of the adhesive layer and the adhesive layer is higher than the adhesion between the release liner covering the inner adhesive surface of the adhesive layer and the adhesive layer.

8. The flashing of claim 1, wherein the substrate is folded outward near the second lateral edge.

9. A method for preventing the ingress of moisture into a wall of a building surrounding a flanged fenestration unit installed in a rough opening of the wall, the wall and the rough opening being defined by framing members, the method comprising:
a) installing the fenestration unit in the rough opening such that the flange of the fenestration unit overlaps the framing members of the rough opening;
b) providing a flashing comprising an elongated substrate selected from the group consisting of nonwoven fabric, woven fabric, film, paper, sheet metal, and a combination thereof, and an elongated adhesive layer having an inner adhesive surface and an outer adhesive surface, wherein the outer adhesive surface of the adhesive layer is adhered to one side of the substrate such that a first portion of the adhesive layer covers a portion of the substrate adjacent one lateral edge of the substrate and a second portion of the adhesive layer extends beyond the lateral edge;
c) adhering the inner adhesive surface of the adhesive layer of the flashing to the flange of the fenestration unit along the sides and uppermost portion of the fenestration unit and to the adjacent framing members of the rough opening; and
d) installing a weather resistive barrier over the wall surrounding the fenestration unit such that the weather resistive barrier is adhered to the outer adhesive surface of the second portion of the adhesive layer along the sides and uppermost portion of the fenestration unit and such that the weather resistive barrier immediately below the lowermost portion of the fenestration unit is covered by the substrate of the flashing.
